(19) United States
(12) Patent Application Publication
(10) Pub. No.: US 2007/0053737 A1
(43) Pub. Date: Mar. 8, 2007

(54) Dispenser for a fluent product

(76) Inventors: Bryan Morris, Geneve (CH); Ralph Wares, Sauverny (FR); Yves M. Trouilhet, Vesenaz (CH); Karlheinz Hausmann, Auvernier (CH); Andrew Horman, Cheserex (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/388,903

(22) Filed: Mar. 24, 2006

Related U.S. Application Data
(60) Provisional application No. 60/714,027, filed on Sep. 2, 2005.

(51) Int. Cl. B43K 5/14

(52) U.S. Cl. 401/133; 401/132

(57) ABSTRACT

A dispenser (10) for use as applicator or evaporator of fluent products (20) in a multitude of applications is constituted as a series of thin layered sheets (30) that can be in credit card format, having one face (32) that is impermeable to the fluent product, and an opposite face (34) with a localized perforated area (40) through which the product can pass and that for many applications is covered by a material that absorbs the fluent product, for instance a woven or non-woven fabric. The thin layered sheet (30) encloses at least one volume of a fluent product contained in at least one generally flat reservoir (36) defined by fluid-tight heat-sealed layers (33-2, 34-1) joined by a frangible seal (60) that is rupturable by the application of pressure. The layered sheet (30) is arranged so that when a reservoir's frangible seal (60) is ruptured the released product (20) passes through the perforated area (40) and is taken in by the absorbent material (50) which serves as an applicator for applying the released product to a surface and/or as an evaporator allowing the released product to evaporate into the atmosphere.

This application claims priority to U.S. provisional application Ser. No. 60/714,027, filed Sep. 2, 2005, the entire disclosure of which is incorporated herein by reference.

This invention relates to a dispenser for a fluent product, constituted as a series of thin layered sheets and serving either as an applicator for the fluent product or to evaporate a semi-liquid or liquid fluent product.

### BACKGROUND OF THE INVENTION

Sheet-like dispensers for such products are known from the prior art, either as applicators for applying the product to a substrate, or as evaporators allowing the product to evaporate into the surrounding atmosphere.

U.S. Pat. No. 6,332,271 discloses an applicator with a conformable sheet of perforated material carrying a flexible reservoir for the product on one side, and having on the other side a removable cover sheet that prior to its removal temporarily closes the perforations and serves also to rigidify the applicator, and by its removal allows the product to pass through the perforations. An absorbent layer can be placed inside the reservoir to store the liquid product.

U.S. Pat. No. 6,312,181 discloses a disposable make-up applicator composed of a non-woven fabric sheet having on one side a product and on the other side an impermeable film whose periphery can be gripped without touching the product.

U.S. Pat. No. 6,167,890 discloses a packaging for a pasty cosmetic product, in the form of a flat bag with perforations on one side through which the user can expel the product.

U.S. Pat. Nos. 5,690,130 and 6,119,704 describe disposable cosmetic sample applicators in the form of a flat layered sheet that contains a pasty product, one face being perforated and one outside face having die-cut applicators that can be removed for applying a product contained inside the sheets. The backing layer can be covered with various materials like cotton, nylon, rayon, non-woven fabrics etc. in which the removable applicator can be die-cut.

U.S. Pat. No. 6,062,234 discloses a layered applicator for single cosmetic application, one embodiment having a non-woven sheet as applicator material on a support sheet, with a cosmetic portion between them.

A container made of multilayered sheets for evaporating aromatic substances is described in U.S. Pat. No. 5,518,790. One side of the layers has deep wells containing the aromatic product. The other side is covered by a layered aroma-impermeable cover having an outer impermeable peel-off sheet over a foamed lamina that stays in place when the peel-off sheet is removed, to allow evaporation of the product via the foamed lamina.

U.S. Pat. No. 5,487,932 discloses a combined fluid storage container and applicator in the form of a folded-over impermeable sheet enclosing a pad containing the fluid, the sheet being openable like a book to expose the fluid-containing pad.

U.S. Pat. No. 5,356,379 discloses an applicator mitt for products like dentifrice, medicaments and shoe polish, formed from a folded and heat-sealed strip packaged in a protective heat-sealed pouch.

U.S. Pat. No. 5,112,152 discloses a combination applicator and package notably for shoe polish, consisting of sheets sealed together to contain the polish and an applicator that can be accessed before exposing the polish.

U.S. Pat. No. 4,798,288 discloses a plastic packing having multiple compartments containing a perfume or insecticide for deodorizing closed spaces, constituted of two liquid-impermeable polymer sheets one of which, on application of an external pressure, ruptures internally for mixing different enclosed substances, leaving the external walls of the packing intact.

U.S. Pat. No. 4,345,716 discloses a sachet formed of sheets of woven or non-woven fabric enclosing a fibrous stuffing that protects a frangible capsule. By crushing the capsule, perfume therein is released and can diffuse into the air through the non-woven cover.

GB 2,349,089-A discloses a progressive-release fragrance dispenser comprising several fragrance containers formed as deep wells in a plastic sheet, the wells being closed by a frangible foil forming a blister-pack with the plastic sheet. The frangible foil is covered by a layer of absorbent material that in turn is enclosed within a liquid-impermeable envelope pierced by a plurality of apertures that are out of register with the wells. By pressing on a well of the blister pack, the corresponding part of the frangible foil is ruptured to release the fragrance which impregnates the absorbent material and evaporates via the apertures in the envelope.

The prior art dispensers are, generally speaking, each limited in their possible applications and there remains a need for an improved sheet-type dispenser that can be used as applicator or dispenser of fluent products for different applications.

The invention sets out to provide a dispenser for use as applicator or evaporator of fluent products in a multitude of possible applications where it can be used to dispense single or multiple small amounts of a fluent product only when the product is needed; that is in the form of thin sheets that can be more or less flexible depending on the application and can be of a compact size suitable for carrying in a pocket, wallet or handbag; is convenient to handle without the user having to contact the product; is simple and convenient to use; is reliable in that it has a low risk of the product leaking; is cost-effective to manufacture; allows easy incorporation of design graphics; overcomes various drawbacks and limitations of the prior sheet-like dispensers for fluent products; and provides new opportunities for dispensing a wide range of fluent products.

### SUMMARY OF THE INVENTION

The invention includes a dispenser for a fluent product comprising or constituted as a series of thin layered sheets, the structure having one face that is impermeable to the fluent product, and an opposite face with a localized perforated area having therein a plurality of apertures through which the product is capable of passing.

### BRIEF DESCRIPTION OF THE DRAWINGS

The invention is further described by way of example with reference to the accompanying drawings, in which:

FIG. 1 is a schematic plan view of an embodiment of the dispenser according to the invention, in credit-card format;

FIG. 2 is a cross-section along line A-A of FIG. 1;

FIG. 3 is a cross-section of a detail at B of FIG. 1, on an enlarged scale;

FIG. 4 is a view of the dispenser of FIG. 1 showing in perspective its layered structure with the layers separated from one another;

FIG. 5 is a plan view of a perforated intermediate layer of the dispenser;

FIGS. 6 and 7 show a variation of FIGS. 1 and 2; and

FIGS. 8 to 12 show dispensers of varied shapes with reservoirs of different configurations.

### DETAILED DESCRIPTION

“Fluent product” means any gas, semi-liquid, liquid, or solid product which has a typical fluid behavior or is a product whose molecules or particles are capable of flowing past each other without substantial limits. Typical fluent products include encapsulated or non-encapsulated fragrances, perfumes, creams, cosmetics, skin-care lotions, deodorants, polishes, pharmaceuticals, disinfectants, insecticides, cleansing solutions or gels, dry cleaner, adhesives, or abrasive liquid or semi-liquid products.

In the dispenser, the outside of the perforated face can serve as an applicator for applying the released product to a surface and/or as an evaporator allowing the released product to evaporate into the atmosphere. For example it carries at least over the perforated area a material that absorbs the fluent product, like a woven or non-woven fabric that acts as applicator and/or evaporator, or a wick serving as evaporator, or the perforated surface can be non-absorbent for instance by being formed as a non-absorbent soft-touch surface that acts as applicator for the released product.

The thin layered sheets making up the dispenser can enclose at least one volume of a fluent product contained in at least one reservoir, generally or substantially flat, circular, oval, rectangular or is a regular or irregular polygon that forms a slight bulge on the side of the impermeable face. By at most forming a slight bulge, this reservoir does not disturb the overall thin sheet configuration of the dispenser.

Each reservoir can be defined by fluid-tight heat-sealed layers joined by a frangible seal that is rupturable by the application of pressure to release the contained product within the layered sheet at the inside of the perforated face.

The layered sheet may be arranged so that when a reservoir's frangible seal is ruptured, the released product passes through the apertures from the inside to the outside of the perforated area, and is taken in by the absorbent material (if present) which serves as an applicator for applying the released product to a surface and/or as an evaporator allowing the released product to evaporate into the atmosphere, or penetrates a non-absorbent perforated surface which serves for application of the product.

The dispenser according to the invention fulfills the aforementioned criteria, as can be seen from the following detailed description of an embodiment and variations.

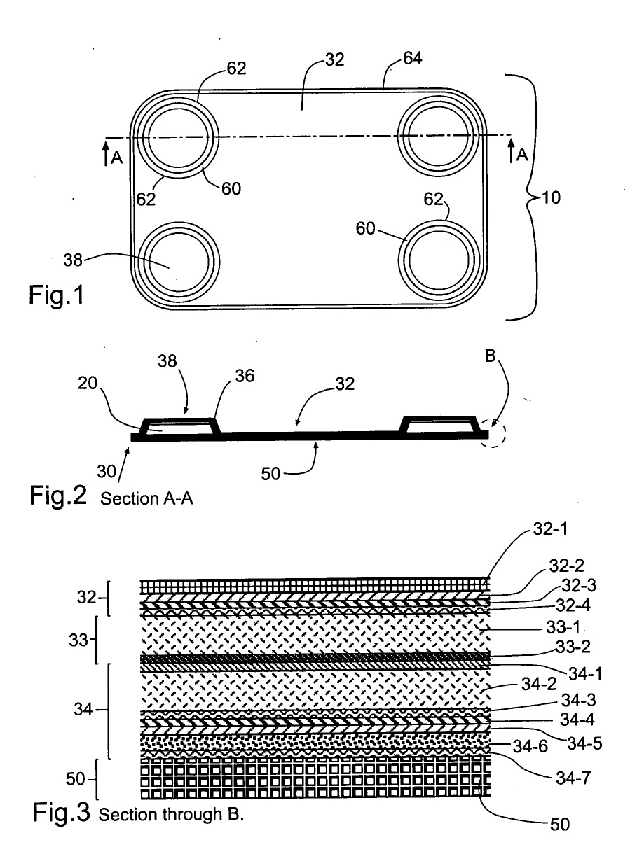

FIGS. 1 to 5 of the drawings show an embodiment of a dispenser 10 for a fluent product 20 for instance a perfume. The dispenser 10 is in the format of a standard generally rectangular credit card measuring approximately 85 cm by 54 cm with rounded corners. It is constituted as a thin multi-layered sheet 30 having one face 32 that is impermeable to the fluent product 20, and an opposite face 34 with a localized central perforated area 40 (see FIG. 5) having therein a plurality of apertures 42 through which the perfume 20 can pass. As shown, the card has a generally rectangular array of 14×14 apertures 42, but other shapes and dispositions of the perforated area 40 are possible and the number and size of the apertures 42 can be adjusted depending on the nature of the fluent product 20 and the intended application.

The product-impermeable face 32 of the card may constitute a scratch-resistant decorated surface that can carry an aesthetically pleasing design.

In this example, the totality of the outside of the perforated face 34 is covered by an absorbent layer 50 of a material that can absorb the perfume or other fluent product 20. The absorbent layer 50 may be made of any suitable woven or non woven fabric. Examples of non woven fabrics are the DuPont® Sontara® non woven fabrics such as the DuPont® Sontara® 8020, Sontara® LP04 and Sontara® LLP5. The thickness of the absorbent layer 50 depends on the application of the dispenser itself and may vary between 200 μm and 2 mm. For perfume dispensers, a thickness of 200 μm may be appropriate. The absorbent layer 50 can be spot heat sealed to the perforated layers 34, for instance by heat sealing it at various places and in particular partly or fully around its edges.

The thin layered sheet 30 encloses at least one volume of the perfume or other fluent product 20 that, in this example, is contained in four generally flat reservoirs 36 located adjacent the four corners of the rectangular sheet 30, and disposed around the central perforated area 40, with or without an overlap. These reservoirs 36 form slight bulges 38 on the side of the impermeable face 32. These slight bulges 38 protrude from the sheet 30 by such a small amount that they do not disturb the overall thin sheet configuration of the dispenser 10. As shown, each reservoir 36 is substantially circular, but alternatively could be oval, rectangular or a regular or irregular polygon.

The generally flat reservoirs 36 are each defined by heat-sealed layers 33-2; 34-1 joined in part by a frangible seal 60 that is rupturable by the application of pressure to release the contained product 20 within the layered sheet 30 at the inside of the perforated face 34, and in part by a hermetic seal 62. The heat-sealed layers 33-2 and 34-1 can be made of blends based of homo or copolymers of polypropylene including up to 40 wt-% of ethylene copolymers such as EMA, the weight percentage being based on the total weight of the blend. Such blends are described for example in US patent application 2004/006180-A1. The layers 33-2 and 34-1 are heat sealed at temperatures between 180 and 200° C. for the permanent seal 62 (which is described below) and between 130 and 160° C. for the frangible seal 60. The frangible seal 60 can be produced between heat-sealable films, as is well known for example from U.S. Pat. Nos. 4,539,263, 4,550,141 and published application US 2004/0118710-A1. These prior art documents disclose blends of partially neutralized ethylene/acid copolymer (i.e., ionomer) with minor amounts of propylene/acid copolymer to make heat-sealable films and laminates. Such structures are characterized by nearly constant peel strength over an extended heat seal temperature range.

Alternatively the frangible seal area can be made up with a peelable material composition as disclosed in US 2004/006180-A1, essentially made up of a polypropylene homo- or copolymer and minor amount of an ethylene acrylate copolymer, or more broadly any peelable sealant composition that allows different seal strength values as a function of sealing temperature.

The reservoirs 36 for the fluent product 20 are defined between the fluid-tight heat sealed layers 33-2 and 34-1 joined by a frangible seal 60, for example a first sheet of polymeric film; a second sheet of polymeric film superimposed on the first sheet of polymeric film wherein the first and second sheets of polymeric film are sealed to each other directly or indirectly through a third intervening polymeric film. The seal strength of the sealed perimeter 62 of the reservoir 36 is sufficient (above about 20 N/15 mm) to withstand manual compression of the contained fluent product 20 whereas the seal strength of the frangible seal 60 is less (below about 15 N/15 mm), so that the frangible interface does not withstand manual compression of the contained fluent product 20, but ruptures. This corresponds to the typical sealing temperatures mentioned above, i.e. between 180 and 200° C. to obtain the hermetic seal and between 130 and 160° C. to provide the frangible seal.

The frangible seal 60 forms a frangible interface along an inwardly-directed arcuate part of a peripheral seal around each reservoir 60, the remaining outwardly-directed part 62 of the seal 60 being a strong hermetic seal that resists rupture. For example the frangible part 60 can occupy 10-50% of the periphery of the reservoir 36 and the hermetically sealed part 62 can occupy 90-50%.

Thus, each reservoir 36 is formed between two fluid-tight heat-sealed layers 33-2 and 34-1 joined by a frangible seal 60 around a part of the reservoir perimeter and a non-frangible seal 62 around the remainder of the reservoir perimeter, with a non-frangible seal 64 around the perimeter of the two heat-sealed layers 33-2 and 34-1. The outer heat-sealed layer 33-2 is imperforate and forms part of the impermeable face, and the inner heat-sealed layer 34-1 includes the apertures 42 of the perforated area 40.

The layers making up the card-like sheet 30 can be sealed around the periphery of the sheet by a peripheral hermetic seal 64, a detail of which is shown in FIG. 3.

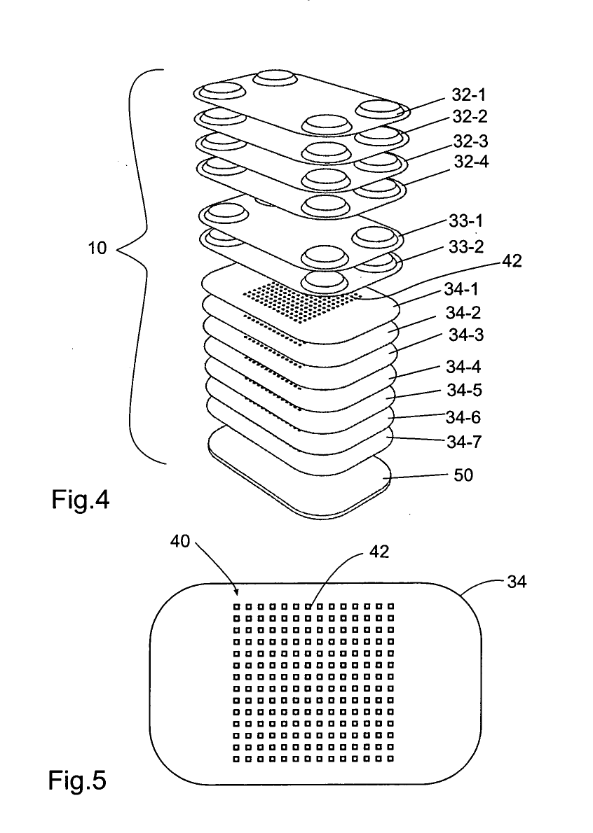

The multilayered structure of the sheet 30 can be seen from FIG. 3, which is a cross-section at the periphery of the sheet, through the peripheral seal 64, and from FIG. 4 which shows the constituent layers separated from one another. As shown, in this example the multilayer sheet is made up in all of fourteen sheets: four sheets 32-1 to 32-4 making up the impermeable face 32, two intermediate sheets 33-1 and 33-2, seven sheets 34-1 to 34-7 forming the perforated face 34, and lastly the layer of absorbent material 50, which can be perforated as well but does not have to be perforated.

The printable layers 32-1 and 34-6 may be thermoformable or cold formable and can be of any material acting as barrier to moisture or to other gases so that diffusion of substances (like for example perfume fragrances) out of the dispenser is prevented or strongly reduced. Advantageously, layers 32-1 and 34-6 have a MVTR (moisture vapor transmission rate) equal to or less than 20 g/m²/day measured according to ASTM 96BW.

Suitable materials may be chosen among oriented PET (OPET), polyamides and polypropylene. OPETs are available, for example, from E. I. du Pont de Nemours and Company, Delaware USA (DuPont), under the trade name Mylar®.

The tie layers 32-2, 34-5 and 34-7 can be of any suitable material such as one or more ethylene copolymers and polyethylene imine water based primers. Examples of ethylene copolymers are ethylene vinyl acetate (EVA) and ethylene alkyl acrylate including ethylene methyl acrylate (EMA), ethylene butyl acrylate (EBA) and ethylene ethyl acrylate (EEA). Such ethylene copolymers are possibly modified with 0.2 to 3 wt-% of a carboxylic acid or carboxylic acid anhydride functionality, the weight percentage being based on the total weight of the ethylene copolymer. Such ethylene copolymers include the vinyl acetate and/or the alkyl acrylate monomers in an amount varying from about 5 to about 35 wt-%, the weight percentage being based on the total weight of the ethylene copolymer.

Such materials are available, for example, from DuPont, under the trade names Bynel®, Appeel®, Elvaloy® AC and Elvax®.

The two barrier layers 32-3 and 34-4 of cold formable aluminum may be used in applications employing cosmetic alcohol-based perfumes or chemicals with a barrier layer to avoid permeation or chemical attack.

The adhesive layers 32-4 and 34-3 can be made of one or more ethylene copolymers mentioned for the layers 32-2, 34-5 and 34-7 (including those modified with carboxylic acid or a carboxylic acid anhydride functionality).

The structural layers 33-1 and 34-2 may be made of any suitable material including one or more of homopolymers and copolymers of polypropylene, polystyrene and high density polyethylene. The material for layers 33-1 and 34-2 may have a melt flow index (MFI) between 1 and 5 g/10 min, measured according to ASTM D-1238 (2.16 kg and 190° C.).

In order to render the dispenser more flexible, for example in the case of a credit card format, layers 34-5 to 34-7 can be replaced by a single layer of an ethylene copolymer such as an ethylene acrylic acid and methacrylic acid copolymer resin. Such materials are available, for example, under the trade name Nucrel® (for example the Nucrel® 0903) from DuPont.

In a particular example, these sheets can have the composition in Tables 1 and 2. This example gives a specific arrangement of the sheets that can vary according to the specific application.

The function and composition of the top thin sheet structure, sheets 32 and 33 of FIG. 3, is given in Table 1.

TABLE I

| | Function Composition; | Thickness |
|---|---|---|
| Layer | Exemplary Trade Name(s) | (micrometers) |
| 32-1 | Thermoformable Printable Layer | 23 |
| | Oriented PET Mylar ® 308¹ | |
| | primed with Mica ® A131x² | |
| 32-2 | Tie Layer (extrusion coated at 320° C.) | 10 |
| | Bynel ® 50E604¹ | |
| 32-3 | Barrier Layer | 45 |
| | Cold formable [polyamide]/[aluminum | |
| | 98/90]/[polypropylene] Formpack ®³ | |
| 32-4 | Adhesive Layer | 10 |
| | Bynel ® 50E604¹ | |
| 33-1 | Structural Layer | 200 |
| | polypropylene homopolymer | |
| | Borealis ® RD 204 CE⁴ | |
| 33-2 | Frangible Seal Layer | 10 |
| | (heat sealed at 200° C./150° C.) | |
| | 65 wt-% Borealis ® RE239 CF⁴ | |
| | 35 wt-% Appeel ® XA843¹ | |

¹available from DuPont.
²available from Mica Corporation USA.
³available from Alcan.
⁴available from Borealis

The function and composition of the layers making up the bottom perforated thin sheet structure 34 and the absorbent layer 50 of the device FIG. 3 are given in Table 2.

TABLE 2

| | Function | Thickness |
|---|---|---|
| Layer | Composition; Exemplary Trade Names | (micrometers) |
| 34-1 | Frangible Seal Layer | 10 |
| | (heat sealed at 200° C./150° C.) | |
| | 65 wt-% Borealis ® RE239 CF⁴; | |
| | 35 wt-% Appeel ® XA843¹ | |
| 34-2 | Structural Layer | 200 |
| | polypropylene homopolymer | |
| | Borealis ® RD 204 CE⁴ | |
| 34-3 | Adhesive Layer | 10 |
| | Bynel ® 50E604¹ | |
| 34-4 | Barrier Layer | 45 |
| | Cold formable [polyamide]/[aluminum | |
| | 98/90]/[polypropylene] | |
| | Formpack ®³⁾ | |
| 34-5 | Tie Layer (extrusion coated at 320° C.) | 10 |
| | Bynel ® 50E604¹ | |
| 34-6 | Structural layer | 23 |
| | Oriented PET Mylar ® 308¹ | |
| | primed with Mica ® A131² | |
| 34-7 | Tie Layer (extrusion coated at 320° C.) | 10 |
| | Bynel ® 22E757¹ | |
| 50 | Absorbent layer | 200 |
| | Non Woven; Sontara ® 8020¹ | |

^{1,2,3, and 4}See footnotes in Table 1.

In this particular example (Tables 1 and 2), the bulges 38 forming the reservoirs 36 can have a height of approximately 1-4 mm and various shapes such as square, oblong, hexagonal, elliptical, crescent shapes or regular polygons. If round, the bulges 38 have diameters for example between 5 to 60 mm usually 10 to 40 mm. In this instance, the reservoirs can contain in total from 1 to 50 ml usually about 1 to 10 ml of the perfume or other fluent product 20.

The size, shape and volumetric capacity of the reservoirs 36 depend on the product being dispensed and the type of end use application.

As illustrated in FIG. 4, all of the layers (33-1 and 32-4 to 32-1) above the upper frangible sealed layer 33-2 have bulged parts in register with the reservoirs 36.

The layered sheet 30 is arranged so that when a reservoir's inwardly-directed frangible seal 60 is ruptured the product 20 is released towards the center of the card, passes through the apertures 42 from the inside to the outside of the perforated area 40 in face 34 and is taken in by the outer layer of absorbent material 50 which serves as an applicator for applying the released product to a surface and/or as an evaporator allowing the released product to evaporate into the atmosphere.

The described credit-card-like sheet 30 is convenient to carry, for example in a handbag or wallet. When the user desires to dispense the perfume or other fluent product 20 he/she simply takes hold of the card-dispenser 10 and presses on one of the bulges 38 to rupture its frangible seal 60. The product 20 is released towards the centre of the card and passes though the apertures 42 into the absorbent sheet 50 which absorbs the product 20 more or less uniformly throughout the entire extent (co-extensive with the card-dispenser 10) and through the thickness of the sheet 50. In the case of a perfume, the user can dab the impregnated sheet 50 against an area of the skin to transfer the perfume onto the skin. Any remaining perfume can gradually be released into the atmosphere by evaporation. This operation can be repeated, as and when required, for the remaining bulges 38 until all of the perfume has been dispensed.

### Variations and Applications

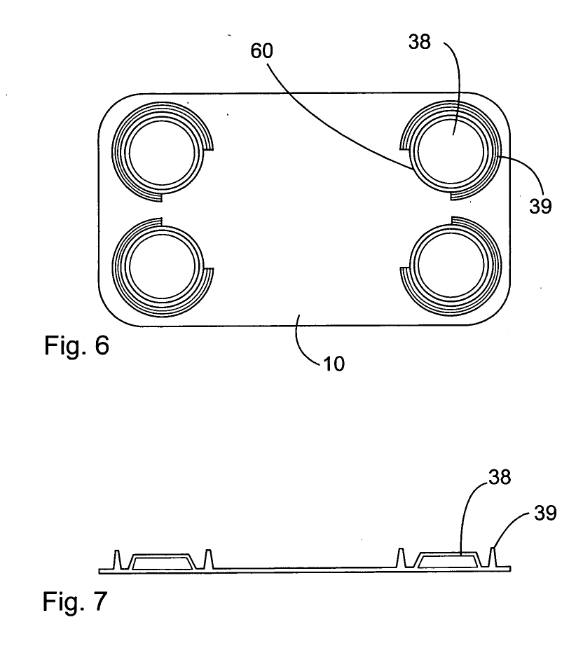

FIGS. 6 and 7 show a variation of FIGS. 1 and 2 where each reservoir/bulge 38 is surrounded by a rim 39 that is just higher than the thickness of the reservoir/bulge 38. As shown, each rim 39 extends about three quarters the way around the reservoir/bulge 38, leaving a free space facing the frangible seal 60. This disposition favors the correct application of pressure to rupture the frangible seal 60. Other dispositions of the rim 39 extending fully or at least partially around the reservoir are possible. These rims 39 are sufficiently strong that they form a protection around the reservoirs/bulges 38 to prevent them from unwantedly being pressed to break their frangible seals.

Generally, the layered sheet 30 is made up entirely or principally of different synthetic plastic materials with suitable properties, but it is possible to incorporate thin, cold formable metal foils such as cold formable aluminum foils 32-3 and 344, as well as sheets of cellulose-based materials such as paper and card that have been impregnated to be impermeable to the fluent product. Cold formable metal foils are typically metal foils laminated on both sides independently with polyamide or polypropylene so that to confer to the metal foil itself the mechanical resistance which may be necessary for undergoing forming at room temperature (25° C). The use of a transparent outer layer or layers on the product-impermeable side 32 facilitates the incorporation of design graphics by standard printing processes. Printing can be done on the inside of the outer layer, to provide a scratch-free decorated surface.

For applications where an absorbent layer like the layer 50 is not needed, the outer face of the perforated sheet(s) 34 can be specially adapted as a product applicator, for example by having a soft-touch surface for comfortable application of the product. For dispensing certain products like adhesives, this surface can be constructed as a wiping spatula.

Instead of the credit card format, the dispenser can be formed as a flexible cloth, for example as an applicator for polish or cleansing products, or as a face of an applicator glove or mitt, or can be formed as an adhesive plaster, in particular for the application of products for skin care.

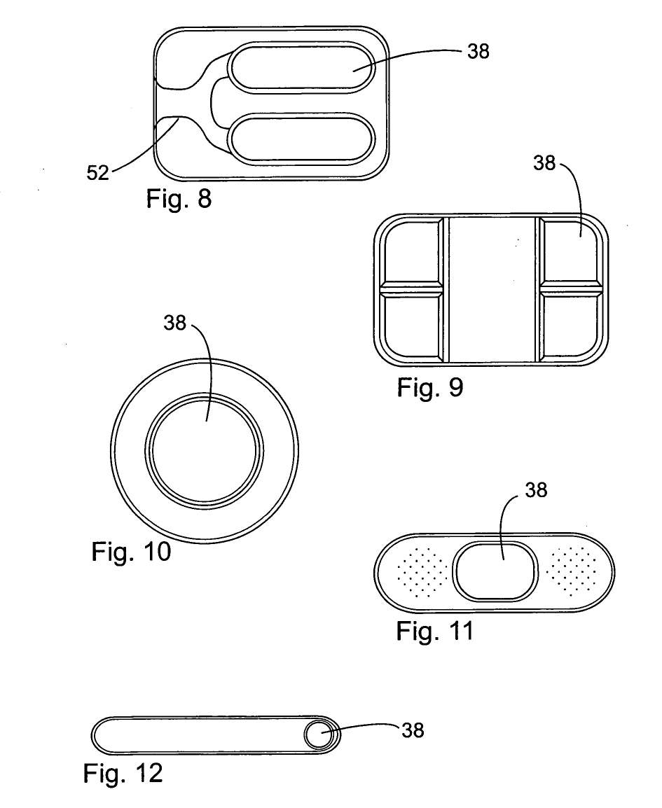

For example, FIG. 8 shows a generally rectangular card having two elongated reservoirs/bulges 38 each containing one component of a two-component adhesive. In this arrangement, the frangible seals 60 lead into a Y-shaped area 52 for mixing of the adhesive components before they are expelled through the perforations on the other side of the card. This 20 embodiment does not need an applicator sheet 50; the products can be applied directly through the perforations.

FIG. 9 shows a generally rectangular card having four reservoirs/bulges 38 at the four corners, each containing a product to be dispensed. Here the reservoirs are generally rectangular but their outer shape follows the shape of the card corner.

FIG. 10 shows a circular dispenser with a central circular reservoir/bulge 38. This shape is suitable for a cleaning cloth etc, and can be fitted with a handle if needed.

FIG. 11 shows a dispenser according to the invention in the form of an adhesive plaster. Here, the reservoir/bulge 38 can for instance contain an antiseptic or a pharmaceutical product. The other side of the plaster adjacent the perforations may have the usual soft pad covered with protective pull-off strips.

FIG. 12 shows an elongated dispenser having a reservoir/bulge 38 at one end. This dispenser can for example be used as a tooth cleaner. In this case, the product in the reservoir/bulge 38 can be a toothpaste, and the other end of the elongated dispenser can be formed as a finger-cap to be held on the user's finger.

For application as a volatile product dispenser, the absorbent material can be formed as a wick that delivers the released product.

The absorbent material 50 and/or the product 20 can contain an abrasive, for example microcapsules for microdermabrasion of the skin.

The absorbent material 50 on the outside of the perforated face 34 can be covered by a peel-off protective layer (not shown), that can also be reclosable and that protects the absorbent material prior to use or after use if needed. A soft-touch non-absorbent outer surface of the perforated face 34 can also be protected by a peel-off protective layer.

In variations, the absorbent material 50 need not cover the entire outside of the perforated face 34 of the thin layered sheet 30. For example, the periphery of the sheet 30 can be free of an absorbent layer, to facilitate gripping without contact with the product.

If needed, a layer of absorbent material 50 can be placed on all or part of both sides of the thin layered sheet 30.

Any number of generally flat reservoirs 36 of specified shapes and sizes can be placed on the dispenser, depending of the volumes of fluent product to be dispensed and the number of separate deliveries of the fluent product. Usually, the perforated area in the perforated face may cover a central part of the thin layered sheet, and each of the at least one reservoir may be located adjacent the periphery of the thin layered sheet around or beside the perforated area.

The thin layered sheet 30 can be made in many different shapes and sizes, from small plaster-sized products to credit card size to hand-sized pads or even larger flexible sheets.

The described dispenser-applicator can be used in combination with a holder for holding the thin layered sheet 30 while allowing the absorbent material 50 or an uncovered perforated face to act as applicator or evaporator of the product 20. For example, the product 20 can be an insecticide or a fragrance to be dispersed in the atmosphere by holding a credit-card shaped sheet 30 in a corresponding support. The card can be inserted in the support after rupturing one of the reservoirs 36, or the support can be provided with an arrangement to rupture a reservoir after insertion of the card.

The dispenser can contain many different fluent products including fragrances, perfumes, creams, cosmetics, skin-care lotions, deodorants, polishes, pharmaceutical products, insecticides, disinfectants, cleansing solutions or gels, dry cleaners, adhesives, or abrasive liquid or semi-liquid products. The composition, amount and the viscosity of such products can be chosen according to the intended applications.

The products mentioned in the above paragraph may be encapsulated in microcapsules having typical sizes between 5 and 500 micrometers and which microcapsules can be broken when mechanical pressure is applied to the outside of the formed bulge. Typical encapsulation techniques can be found for example in EP0026 914, EP0218887 and EP0978312.

In the case of encapsulated products, the barrier layers 32-3 and 344 (as well as the relative adhesive layers 32-4 and 34-3, tie layer 34-5 and structural layer 34-6) may not be necessary, particularly in the case when the microcapsules cannot accidentally and unintentionally break during storage in the dispenser. Applications of the dispenser include primary cosmetics packaging as well as cosmetic samplers, for perfumes, creams etc; personal care products such as nail cleaners and for skin microdermabrasion etc; personal care plasters for medical applications and as cream dispensers onto plaster pads; car care kits for polishing of cars; lens cleaners for glasses; home polishing kits inter alia for shoe polish; textile and clothes cleaners, in particular for ties; baby wipes; mixer-applicator for adhesives, especially for mixing two-component adhesives; evaporators for perfuming the surrounding atmosphere (rooms, wardrobes or cars for example). Other applications are of course possible.

1. A dispenser for a fluent product comprising, or constituted as, a thin layered sheet having one face that is impermeable to the fluent product, and an opposite face with a localized perforated area having therein a plurality of apertures there through the product is capable of passing thereby forming released product.

2. The dispenser of claim 1 wherein
the outside of the opposite face serves as an applicator for applying the released product to a surface and/or as an evaporator allowing the released product to evaporate into the atmosphere,
the layered sheet encloses at least one volume of fluent product contained in at least one reservoir,
each of the at least one reservoir is defined by fluid-tight heat-sealed layers joined by a frangible seal, and
the layered sheet is arranged so that when a reservoir's frangible seal is ruptured the released product passes through the apertures from the inside to the outside of the opposite face with a localized perforated area.

3. The dispenser of claim 2 wherein the at least one reservoir forms a slight bulge on the side of the impermeable face and the frangible seal that is rupturable by the application of pressure to release any product within the layered sheet inside the opposite face with a localized perforated area.

4. The dispenser of claim 3 in the format of a standard credit card, a flexible cloth, an adhesive plaster, or combinations of two or more thereof and the face that is impermeable to the fluent product is scratch-resistant and decorated.

5. The dispenser of claim 4 wherein the perforated area covers a central part of the layered sheet, each of the at least one reservoir is located adjacent the periphery of the layered sheet around or beside the perforated area, and the at least one reservoir is substantially flat, circular, oval, rectangular, or polygon.

6. The dispenser of claim 2 wherein the layered sheet is generally rectangular and comprises four reservoirs located adjacent four corners of the layered sheet.

7. The dispenser of claim 5 wherein the layered sheet is generally rectangular and comprises four reservoirs located adjacent four corners of the layered sheet.

8. The dispenser of claim 2 wherein the outside of the opposite face with a localized perforated area carries at least over the perforated area an absorbent material that is optionally a woven or non-woven fabric or a wick and is optionally covered by a peel-off protective layer.

9. The dispenser of claim 3 wherein the outside of the opposite face with a localized perforated area carries at least over the perforated area an absorbent material that is optionally a woven or non-woven fabric or a wick and is optionally covered by a peel-off protective layer.

10. The dispenser of claim 7 wherein the outside of the opposite face with a localized perforated area carries at least over the perforated area an absorbent material that is optionally a woven or non-woven fabric or a wick and is optionally covered by a peel-off protective layer.

11. The dispenser of claim 9 wherein the absorbent material covers the entire outside of the opposite face with a localized perforated area of the layered sheet.

12. The dispenser of claim 10 wherein the absorbent material covers the entire outside of the opposite face with a localized perforated area of the layered sheet.

13. The dispenser of claim 9 wherein the outside of the perforated face has a surface that does not absorb the product and that serves as an applicator for applying the released product.

14. The dispenser of claim 12 wherein the outside of the perforated face has a surface that does not absorb the product and that serves as an applicator for applying the released product.

15. The dispenser of claim 3 wherein the bulge is surrounded by a rim, or at least partially by a rim, protecting the frangible seal from being ruptured inadvertently.

16. The dispenser of claim 13 wherein the bulge is surrounded by a rim, or at least partially by a rim, protecting the frangible seal from being ruptured inadvertently.

17. The dispenser of claim 14 wherein the bulge is surrounded by a rim, or at least partially by a rim, protecting the frangible seal from being ruptured inadvertently.

18. The dispenser claim 16 in combination with a holder for holding the thin layered sheet while allowing at least a part of the outside of the perforated face to serve as an applicator for applying the released product.

19. The dispenser claim 17 in combination with a holder for holding the thin layered sheet while allowing at least a part of the outside of the perforated face to serve as an applicator for applying the released product.

20. The dispenser of claim 2 wherein the contained fluent product comprises an encapsulated or non-encapsulated fragrance, perfume, cream, cosmetic, skin-care lotion, deodorant, polish, pharmaceutical, insecticide, disinfectant, cleansing solution or gel, dry cleaner, adhesive, or an abrasive liquid or semi-liquid product.
